(19) United States
(12) Patent Application Publication
(10) Pub. No.: US 2002/0111060 A1
(43) Pub. Date: Aug. 15, 2002

(54) Connector housing having secondary locking

(76) Inventors: Richard John Challis, Middlesex (GB); Derek Richard Terry, London (GB); Michael Joseph Gerard Whelan, Bedfordshire (GB)

Correspondence Address: Tyco Technology Resources, Suite 450, 4550 New Linden Hill Road, Wilmington, DE, 19808, US

(21) Appl. No.: 09/950,952

(22) Filed: Sep. 13, 2001

(30) Foreign Application Priority Data
Sep. 15, 2000 (EP) 00120082.3

(51) Int. Cl. H01R 13/627

(52) U.S. Cl. 439/352

(57) ABSTRACT

A connector (4) having a connector housing (6) with a contact passageway (12) for receiving a contact (40), an opening (64) extending into the contact passageway (12), and a secondary locking member (14) with a retention arm (58) that has a retention head (60) thereupon, where in a first position of the secondary locking member (14) the contact (40) is insertable into the contact passageway (12) and a second position the retention head (60) extends through the opening (64) into the contact passageway (12) to prevent the contact (40) from being withdrawn, the opening (64) is defined by a shoulder (66) and an overhanging supporting member (68), the retention head (64) including a retention shoulder (70) facing the shoulder (66) and an abutting surface (72) facing the overhanging supporting member (68), where upon telescopic movement of the secondary locking member (14) from the first position to the second position the overhanging supporting member (68) and the abutting surface (72) co-operate to guide the retention head (60) into the passageway (12) and engage one another if a pull-out force were to be exerted upon the contact (40) in a supporting manner. Additionally, the connector (4) includes a latch (16) that has a main latch arm (20) with an abutment portion (38) that upon depression of an actuation portion (28) of the main latch arm (20) establishes a fulcrum (36) upon a mating connector (18) in order to lift the latch (16) from the catch (30).

### FIELD OF THE INVENTION

This invention relates to an electrical connector and a secondary locking mechanism for retaining contacts therein.

### BACKGROUND OF THE INVENTION

It is well known to incorporate secondary locking in connectors to assure that contacts therein are retained. There are various configurations of these secondary locking devices but it is common that the connector includes an auxiliary member, known as a secondary locking member, that provides the secondary locking. This auxiliary member generally has a first position where the contacts can be inserted into the connector housing and a second position where the contacts are positively retained in the housing.

In one configuration, the secondary locking member is positioned on the connector housing. The connector housing includes contact passageways therethrough. Along the connector housing, there is a opening that is in communication with the contact passageway for receiving a rigid tab or shoulder formed as part of the plastic moulded secondary locking member. In this style of secondary locking, in the first position, the tab or shoulder is positioned clear of the passageway so that the contacts may be inserted therein and then moved either down into the passageway from outside, as shown in U.S. Pat. No. 5,076,806, or moved across the passageway from a side thereof, as shown in U.S. Pat. 5,692,929. While this configuration performs acceptably, where substantial forces might be exerted on the contacts or the size of the tab must be small; there is the possibility that the tab will fail.

Another style of secondary locking member involves providing a resilient arm with a locking head as part of the connector housing along the contact passageway. When the contact is inserted therein, the arm resiles so that the locking head moves out of the way and then deflects back to retain the contact. In order to prevent the resilient arm from deflecting again when a pull-out force is exerted on the contact, the secondary locking member will support the resilient arm in a manner that prevents deflection, such as by blocking the arm with a supporting member. An example of this style is shown in U.S. Pat. No. 4,973,268. While this style functions well also, the same basic problem exists if the pull-out forces are large in that the locking head is still susceptible to damage.

In order to protect the locking head, it is known from U.S. Pat. No. 5,593,326 to provide a secondary locking member upon a connector housing that moves both transversely and longitudinally along the contact passageways so that a rigid retention member moves into the passageway to retain the contact therein. The retention member includes a locking head, as described above, that co-operates with the housing to support the locking head in a manner that helps prevent damage to the locking head. However, this configuration is quite complex in the method of actuation and it would be desirable to have a secondary locking member incorporating the desirable feature of supporting the locking head without the difficulties associated with the complex transverse and longitudinal movements needed to bring the secondary locking member into the second (locked) position.

### SUMMARY OF THE INVENTION

Therefore, it is an object of the present invention to provide secondary locking that is capable of withstanding significant pull-out forces without damage to the secondary locking mechanism. It is yet another object of this invention to provide support for the actual secondary locking feature that interacts with the contact to prevent failure thereof. It is still yet another object of this invention that the secondary locking member is simple to actuate.

These and other objects are accomplished by providing a connector having a connector housing having a contact passageway therethrough for receiving a contact therein. An opening extends transversely through the housing and into communication with the contact passageway. A secondary locking member having a retention arm with a retention head thereupon extends into the opening. Where in a first position of the secondary locking member the retention head is positioned such that the contact is insertable into the contact passageway and a second position where the retention head extends into the contact passageway to prevent the contact from being withdrawn from the contact passageway. The opening of the connector is defined by a shoulder and an overhanging supporting member and a shoulder. The retention head has a retention shoulder facing the shoulder and an abutting surface facing the overhanging supporting member. Upon telescopic movement of the secondary locking member from the first position to the second position, the overhanging supporting surface and the abutting member cooperate to guide the retention head into the passageway and engage one another if a pull-out force were to be exerted upon the contact in a supporting manner.

It is an advantage of one embodiment of the present invention that the secondary locking member moves telescopically upon the connector housing. It is an advantage of one embodiment of the present invention that the locking head or tab is disposed upon a resilient arm that deflects into the contact passageway upon displacement of the secondary locking member.

### BRIEF DESCRIPTION OF DRAWINGS

An embodiment of this invention will now be described by way of example with reference to the accompanying drawings in which;

FIG. 1 is a perspective view of a connector assembly prior to mating incorporating the present invention;

FIG. 2 is a sectional view of the mated connector assembly of FIG. 1;

FIG. 3 is a cross-sectional view through one of the connector halves configured to receive contacts therein;

FIG. 4 is a detail view from FIG. 3;

FIG. 5 is a cross-sectional view corresponding to FIG. 3 configured to retain contacts therein;

FIG. 6 is a detail view from FIG. 5.

### DETAILED DESCRIPTION OF EMBODIMENT SHOWN

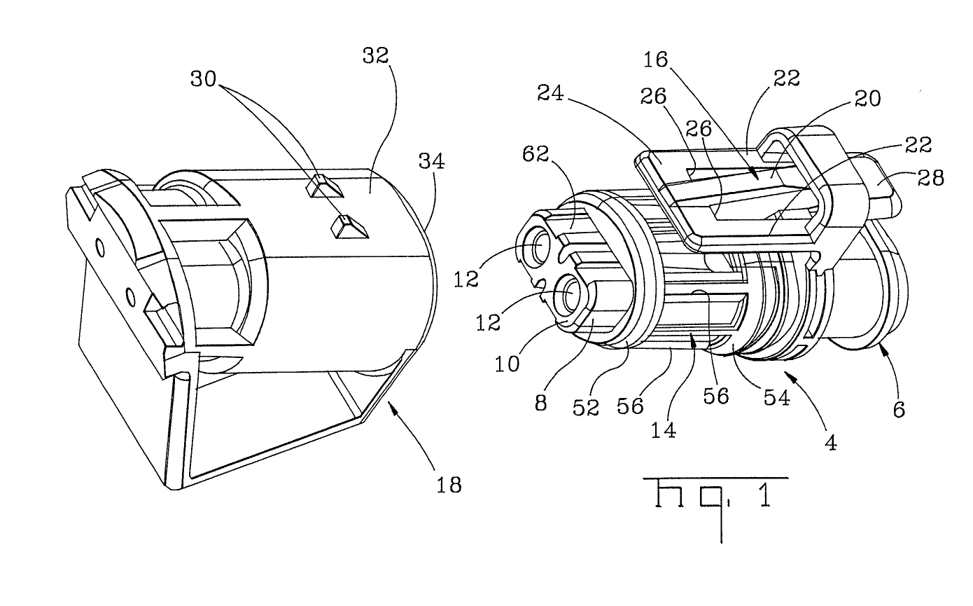

Referring to the figures, particularly FIG. 1, a connector assembly 2 comprises a connector 4 having a connector housing 6. The connector housing 6 includes a nose portion 8 with a mating interface 10. A pair of contact passageways 12 extend through the connector housing 6 and are open at the mating interface 10. A secondary locking member 14 is disposed upon the nose portion 8 and is telescopically movable therealong.

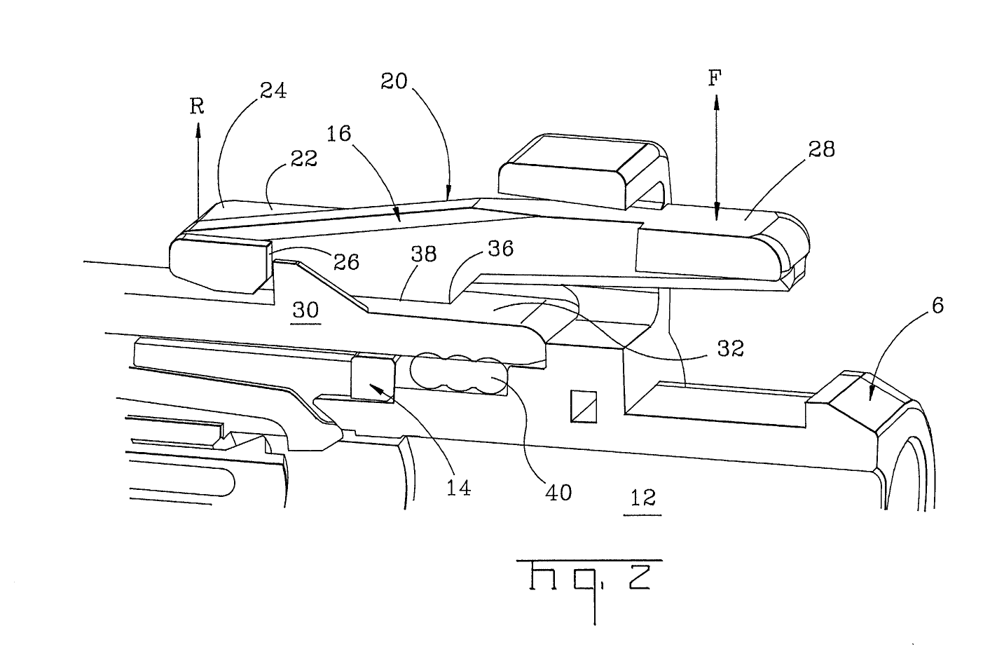

Further, the connector 4 includes a latch structure 16 for retaining the connector 4 with a mating connector 18. As best shown in FIG. 2, the latch structure includes a main latch beam 20 that is cantilevered outward from within a U-shaped supporting structure that includes resilient beams 22 that are spanned by a support bar 24 from which the main latch beam 20 extends. As the resilient beams 22 are spaced from the main latch beam 20, shoulders 26 are defined on either side thereof along the support bar 24. The main latch beam 20 includes an actuating portion 28 for releasing the shoulders 26 of the latch 16 from catches 30 disposed on the mating connector 18, as will be described below.

Referring to FIG. 1, the mating connector 18 includes a shroud 32 upon which the catches 30 are disposed. The shroud 32 further surrounds a mating interface 34 of the mating connector 18. The shroud 32 is configured to telescopically receive the nose portion 8 with the secondary locking member 14 thereupon of the connector 4 when the connector 4 and the mating connector 18 are mated.

With reference now to FIG. 2, the connector assembly 2 is shown with the connector 4 and the mating connector 18 in the mated condition. In this partial sectional view showing the latch 16 engaged with the catch 30, it is apparent that during mating of the connector assembly 2, the support beam 24 rides over the advantageously configured catch 30 and then resiles back so that the support beam 24 is disposed behind the catch 30. Further, the shoulder 26, defined between the main latch beam 20 and the support beams 22, is positioned so that the connector 4 and the mating connector 18 cannot be de-mated without actuating the latch 16.

However, as the main latch beam 20 is connected to the support beam 24 in a cantilevered manner, there is no integral pivot point associated with the latch 16 of the connector 4 about which a force F, exerted on the actuation member 28, would result in the lifting of the support bar 24 in the direction R in order to disengage the should 26 from the catch 30. Instead, a fulcrum 36 is established along an abutment portion 38 of the main latch beam 20 where the abutment portion 38 comes into contact with the shroud 32 of the mating connector 18. Once this fulcrum is established, further depression of the actuation member 28 of the main latch beam 20, by exerting force F thereupon, results in the support bar 24 lifting in the direction R such that the shoulders 26 are clear of the catch 30.

With reference now to FIG. 3, the connector 4 is shown with the secondary locking member 14 disposed in a first position in order to receive a contact 40 from a rear end 42 of the contact passageway 12. Although not shown, the contact 40 would typically have a conductor trailing therefrom that would extend out the rear end 42 of the contact passageway 12. The contact 40 includes a resilient locking lance 44 that acts as an initial contact retention feature. As the contact 40 is inserted into the contact passageway 12, the locking lance 44 is deflected until passing a shoulder 46 whereupon the locking lance 44 resiles and prevents the contact 40 from moving back out of the contact passageway 12, as is well known in the art. The contact further includes a retention shoulder 48. In this particular example, the retention shoulder 48 acts to prevent over-insertion of the contact 40 into the passageway since the passageway 12 further includes a second shoulder 50 upon which the retention shoulder 48 would abut to stop insertion of the contact 40. It would also be possible to provide other features to prevent over-insertion of the contact such as reducing the contact passageway 12 at the mating interface 10.

The secondary locking member 14 includes a pair of spaced apart frame-like front and rear members 52,54 that are connected together by way of supporting members 56. This can also be seen in FIG. 1. Locking arms 58 are positioned between the supporting members 56 in a cantilevered manner such that they extend from the front member 52 towards the rear member 54. The locking arms 58 include a retention head 60. During assembly of the secondary locking member 14 upon the nose portion 8 of the connector housing 6, the nose portion 60 travels in a track 62 (best seen in FIG. 1). It may be advantageous to include a positive positioning feature therealong for the locking arm 58 to co-operate with so that separate latch and catch structure is not required to retain the secondary locking member 14 in the first position where the contacts 40 can be inserted into the connector 4. As shown in FIG. 3, the first position of the secondary locking member 14 is established with the retention head disposed within an opening 64 that extends transverse the nose portion 8 and into communication with the contact passageway 12. It is advantageous that while the retention head 60 is positioned within the opening 64, the retention head does not extend into the contact passageway 12 and hence would not interfere or come into contact with the contact 40 during insertion thereof, thereby reducing assembly forces required to insert the contacts 40 and avoiding damage to either the retention head 60 or the contacts 40.

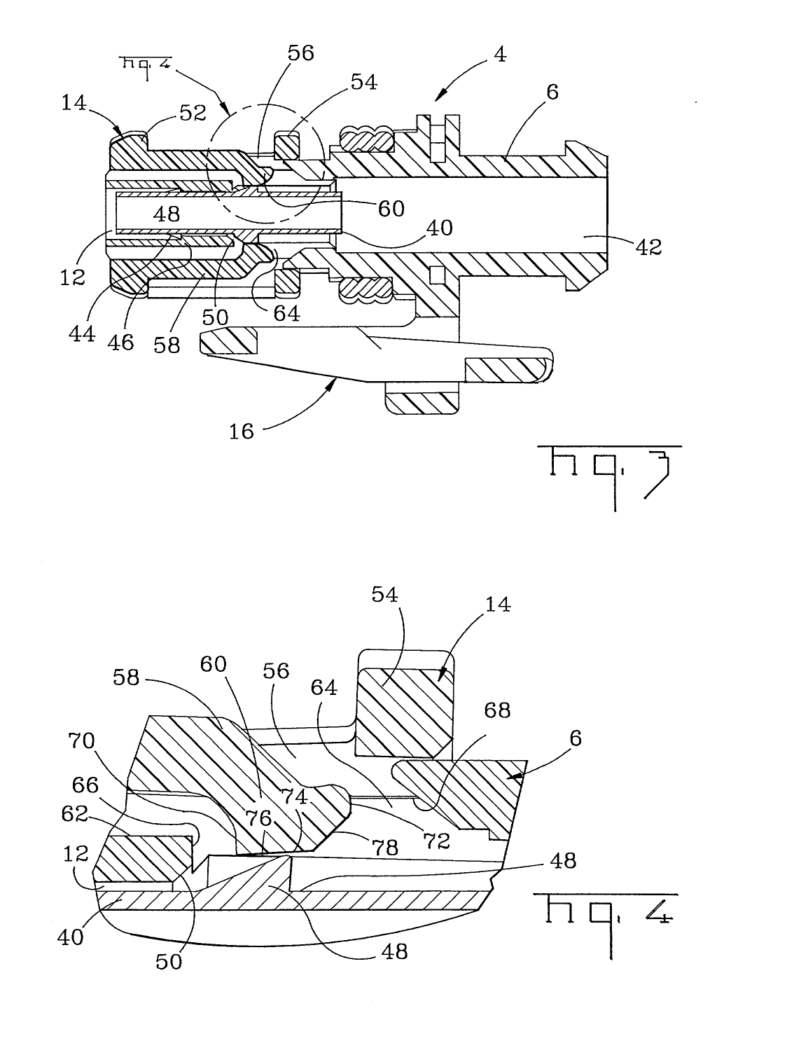

With reference now to FIG. 4, the retention arm 58 can be more clearly seen with the retention head 60 disposed below the track 62 and within the opening 64 but not so far as to enter the contact passageway 12. The opening 64 is defined in-part by a shoulder 66 at the end of the track 62 and a supporting ledge 68 configured to overhang the opening 64 and the contact passageway 12. The retention head includes a locking shoulder 70 facing the shoulder 66 and a protruding and curved support member 72 generally facing the supporting ledge 68. The locking shoulder 70 and the curved support member 72 are joined together by a compound angled section 74 that includes a shallow angled portion connected to the locking shoulder 70 and a steeper angled section 78 connected to the curved support member 72, whereby the amount of material within the retention head 60 can be maximised to enhance retention of the contact 40.

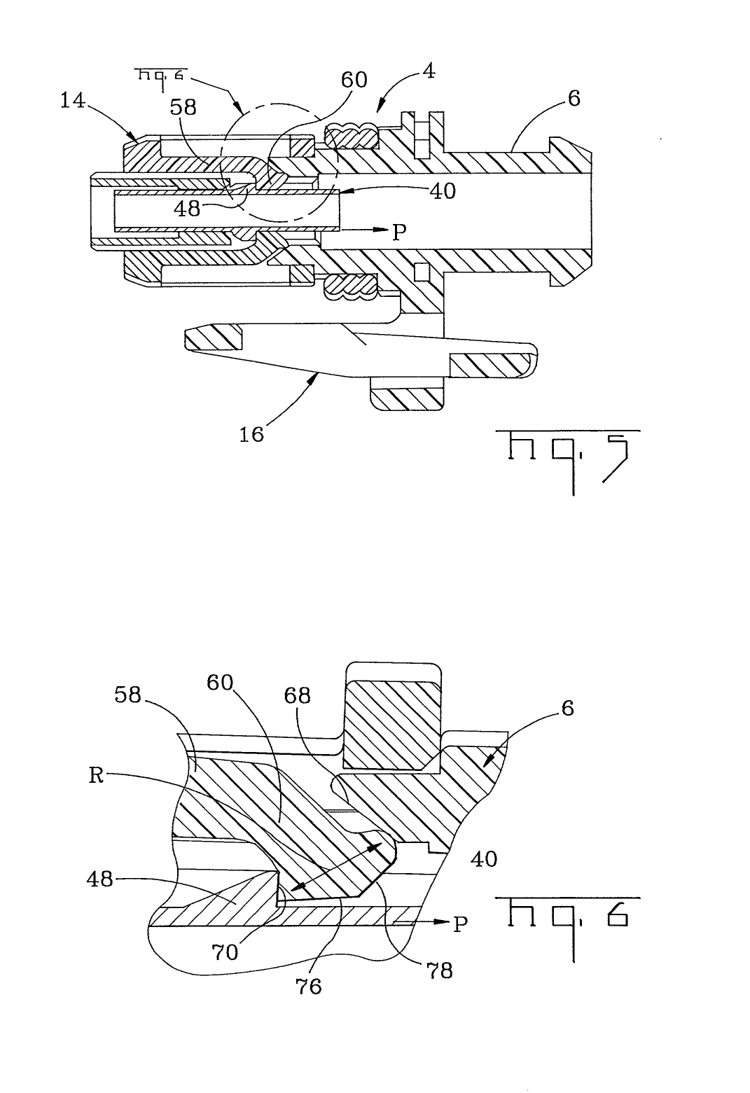

With reference now to FIGS. 5 and 6, the secondary locking member 14 is displaced into the second position where the contact 40 is positively retained within the contact passageway 12 and the connector 4. The second position is achieved by moving the secondary locking member 14 telescopically straight along the nose portion 8 of the connector housing 6 from the first position, as seen in FIGS. 3 and 4, towards the rear end 42 of the connector housing 6. As a result of this movement, the curved support member 72 comes into contact with the overhanging supporting ledge 68. Further displacement of the secondary locking member 14 causes the retention head 60 to be moved into the contact passageway 12 such that the retention shoulder 70 is behind the retention shoulder 48 of the contact 40 as a result of a camming action that occurs between the curved support member 72 and the overhanging supporting ledge 68. It may also be desirable to form the retention arm 58 with at east some bias inward such that the forces needed to displace the secondary locking member 14 do not also have to overcome the complete resiliency of the retention arm 58.

While this is an advantageous mechanism to bring the retention shoulder 70 behind the retention shoulder 48 of the contact 40, the configuration of the retention head 60 10 serves an additional and highly useful purpose. With reference to FIG. 6, should a significant pull-out force P be exerted upon the contact 40 such as when the trailing wire is pulled, the retention shoulder 48 of the contact will engage the retention shoulder 70 of the retention head 60. If the force were large enough, this would tend to push the retention head 60 out of the way. However, because the overhanging supporting ledge and the curved supporting surface are in close proximity to one another, after a very short displacement, they engage one another and prevent the retention head from being pushed out of the way. As can be seen, the more pull that is exerted upon the contact 40, the more trapped the contact 40 becomes. The configuration of the retention head with the compound angled surface 74, enables sufficient material to be included in the retention head 60 to prevent the retention head from being deformed as a result of the increased pull-out forces the secondary locking member can now with stand.

1. A connector assembly comprising a connector having a latch with a main latch arm with an actuation portion and a shoulder and a mating connector where the mating connector having a catch, where upon mating the shoulder of the latch is disposed behind the catch to prevent the connector and the mating connector from becoming de-mated and to de-mate the connector and the mating connector, the actuation portion is depressed lifting the shoulder from the catch, the main latch arm includes an abutment portion that upon depression of the actuation portion establishes a fulcrum upon the mating connector in order to lift the shoulder from the catch.

2. The connector as recited in claim 1 wherein the main latch arm is cantilevered outward from within a U-shaped supporting structure that includes resilient beams that are spanned by a support bar from which the main latch beam extends.

3. The connector as recited in claim 2 wherein the resilient beams are spaced from the main latch beam, the shoulders are defined on either side thereof along the support bar.

4. The connector as recited in claim 1 wherein the mating connector has a shroud upon which the catches are disposed.

5. A connector comprising a connector housing comprising a contact passageway therethrough for receiving a contact therein with an opening extending transversely through the housing and into communication with the contact passageway, and a secondary locking member having a retention arm with a retention head thereupon that extends into the opening, where in a first position of the secondary locking member the retention head is positioned such that the contact is insertable into the contact passageway and a second position where the retention head extends into the contact passageway to prevent the contact from being withdrawn from the contact passageway, the opening is defined by a shoulder and an overhanging supporting member, the retention head including a retention shoulder facing the shoulder and an abutting surface facing the overhanging supporting member, where upon telescopic movement of the secondary locking member from the first position to the second position the overhanging supporting member and the abutting surface co-operate to guide the retention head into the passageway and engage one another if a pull-out force were to be exerted upon the contact in a supporting manner, thereby maintaining the retention head in the contact passageway.

6. The connector as recited in claim 5 wherein the secondary locking member includes a pair of spaced apart frame-like front and rear members that are connected together by way of supporting members.

7. The connector as recited in claim 6 wherein the locking arms are positioned between the supporting members in a cantilevered manner such that they extend from the front member towards the rear member.

8. The connector as recited in claim 5 wherein with the retention head positioned in the first position, the retention head is positioned within the opening and does not extend into the contact passageway such that the retention head does not engage the contact during insertion thereof.

9. The connector as recited in claim 5 wherein the retention shoulder and the abutting surface are joined together by a compound angled section.

10. The connector as recited in claim 9 wherein the compound angled section has a shallow angled portion connected to the retention shoulder and a steeper angled section connected to the abutting surface, whereby the amount of material within the retention head can be maximised to enhance retention of the contact.

11. The connector as recited in claim 5 wherein wherein the retention arm is biased inward such that the forces needed to displace the secondary locking member do not have to overcome the complete resiliency of the retention arm.
